(19) United States
(12) Patent Application Publication
(10) Pub. No.: US 2017/0372354 A1
(43) Pub. Date: Dec. 28, 2017

(54) DETERMINING CAMPAIGN EFFECTIVENESS

(71) Applicant: Google Inc., Mountain View, CA (US)

(72) Inventors: Vedat Taylan Yildiz, Palo Alto, CA (US); Jeffrey D. Oldham, San Jose, CA (US); Sergio F. Marti, Sunnyvale, CA (US); Gabriel C. Hughes, London (GB); Michael E. Pearmain, Guildford Surrey (GB); Matthew J. Trojanovich, Woking (GB); Damien Allison, Surbiton (CA); Nicolas H. Remy, Louveclennes (FR); James R. Koehler, Boulder, CO (US); Rajeshwar Manjunath Shenoy, Fremont, CA (US)

(73) Assignee: Google Inc., Mountain View, CA (US)

(21) Appl. No.: 14/043,591

(22) Filed: Oct. 1, 2013

Related U.S. Application Data
(63) Continuation of application No. 12/889,355, filed on Sep. 23, 2010, now abandoned.

(51) Int. Cl. G06Q 30/02

(52) U.S. Cl. CPC G06Q 30/0246

(57) ABSTRACT

A computer-implemented method includes generating a test group for a pointer to information; generating a control group for the pointer to information; receiving conversion information from the test group and the control group; and determining, based on the conversion information, a number of incremental conversions that are attributable to the pointer.

### TECHNICAL FIELD

This document relates generally to determining an impact of a campaign advertisement on a number of conversions for a product that is the subject of the campaign advertisement.

### BACKGROUND

In advertising, an advertiser may run a marketing campaign that sends a consumer multiple campaign advertisements for a product. For example, a marketing campaign that is promoting digital cameras may send an e-mail campaign advertisement to a consumer and may also display a campaign advertisement on a website that is viewed by the consumer. The consumer may make a “conversion” by purchasing the digital camera that was promoted by the campaign advertisements. Generally, a “conversion” includes a consumer's performance of an action that was the intended result of a campaign advertisement, for example, a consumer's purchase of a product that was advertised in the campaign advertisement. Additionally, a conversion may also include a performance of any pre-defined action by the experimenter of a system.

In this example, the advertiser may seek to determine how much the email campaign advertisement influenced the consumer's decision to purchase the digital camera and how much the campaign advertisement displayed on the website influenced the consumer's decision to purchase the digital camera. That is, the advertiser may want to determine how much of the conversion is “attributable” to (e.g., resulted from) the email campaign advertisement and how much of the conversion is attributable to the campaign advertisement that was displayed on the website.

In this example, the email campaign advertisement may have partially attributed to 30% of the conversion, for example, because the email campaign advertisement made the consumer aware of the digital camera and introduced the consumer to the idea of purchasing the digital camera. The campaign advertisement, which was displayed on a website of a publisher, may have partially attributed to 70% of the conversion, because the campaign advertisement that was displayed on the website included a “click-through link” that the consumer selected to initiate a purchase of the digital camera.

### SUMMARY

In one aspect of the present disclosure, a computer-implemented method includes generating a test group for a pointer to information; generating a control group for the pointer to information; receiving conversion information from the test group and the control group; and determining, based on the conversion information, a number of incremental conversions that are attributable to the pointer.

Implementations of the disclosure may include one or more of the following features. In some implementations, the method also includes determining, based on the conversion information, a total number of conversions for the pointer; and determining, based on the conversion information, a number of control conversion for the pointer. The method may also include determining an incremental conversion rate by: subtracting the number of control conversions for the campaign advertisement from the total number of conversions, weighted to account for a different size of the test and control groups.

In still other implementations, the method includes generating, based on the conversion information, attribution information, wherein the attribution information comprises information that specifies whether an aggregate number of conversions are attributable to the pointer or are naturally occurring. In some implementations, the pointer includes a first pointer, and the method further includes: generating, based on the conversion information, attribution information, wherein the attribution information comprises information that specifies whether an aggregate number of conversions are attributable to the first pointer or to a second pointer.

In other implementations, the method also includes generating one or more tags for insertion into a conversion page associated with the pointer, wherein the one or more tags perform one or more of (i) tracking exposure of one or more of the pointer and the control advertisement, and (ii) tracking one or more of an identity of a computing device, a login ID, a cookie from which a conversion is made.

In another aspect of the disclosure, a computer-implemented method includes assigning a campaign advertisement to a test group of consumers, wherein the campaign advertisement promotes one or more of a product and a service; assigning a control advertisement to a control group of consumers, wherein the control advertisement comprises content that is independent from the campaign advertisement; receiving conversion information from one or more of the test group of consumers and the control group of consumers, wherein the conversion information comprises information specifying whether a particular consumer made a conversion after an exposure to the campaign advertisement or after an exposure to the control advertisement; and determining, based on the conversion information, a weighted number of incremental conversions that are attributable to the test group, wherein the weighted number of incremental conversions comprises information indicative of a number of consumers who made conversions due to the campaign advertisement. Implementations of this aspect of the present disclosure can include one or more of the foregoing features.

In still another aspect of the disclosure, a computer-implemented method includes generating a test group for a campaign advertisement; generating a control group for a control advertisement; receiving conversion information from one or more of the test group and the control group; and determining, based on the conversion information, one or more of (i) a frequency of exposure for the campaign advertisement, (ii) an impact of an advertising budget reduction on a number of incremental conversions for the campaign advertisement, and (iii) an impact of the campaign advertisement on a volume of advertiser-related search queries. Implementations of this aspect of the present disclosure can include one or more of the foregoing features.

In yet another aspect of the disclosure, one or more machine-readable media are configured to store instructions that are executable by one or more processing devices to perform functions including generating a test group for a pointer to information; generating a control group for the pointer to information; receiving conversion information from the test group and the control group; and determining, based on the conversion information, a number of incremental conversions that are attributable to the pointer. Implementations of this aspect of the present disclosure can include one or more of the foregoing features.

In still another aspect of the disclosure, an electronic system includes one or more processing devices; and one or more machine-readable media configured to store instructions that are executable by the one or more processing devices to perform functions including: generating a test group for a pointer to information; generating a control group for the pointer to information; receiving conversion information from the test group and the control group; and determining, based on the conversion information, a number of incremental conversions that are attributable to the pointer. Implementations of this aspect of the present disclosure can include one or more of the foregoing features.

In another aspect of the disclosure, an electronic system includes means for generating a test group for a pointer to information; generating a control group for the pointer to information; receiving conversion information from the test group and the control group; and determining, based on the conversion information, a number of incremental conversions that are attributable to the pointer. Implementations of this aspect of the present disclosure can include one or more of the foregoing features.

All or part of the foregoing may be implemented as a computer program product including instructions that are stored on one or more non-transitory machine-readable storage media, and that are executable on one or more processing devices. All or part of the foregoing may be implemented as an apparatus, method, or electronic system that may include one or more processing devices and memory to store executable instructions to implement the stated functions.

The details of one or more embodiments are set forth in the accompanying drawings and the description below. Other features, objects, and advantages will be apparent from the description and drawings, and from the claims.

### DESCRIPTION OF DRAWINGS

FIG. 1 is a conceptual diagram of a system for determining an effectiveness of a campaign advertisement.

FIG. 2 is a conceptual diagram of how the system determines whether a conversion is attributable to the campaign advertisement.

FIG. 3 is a block diagram of components of the system for determining the effectiveness of the campaign advertisement.

FIG. 4 is a flowchart of a process performed by a campaign manager for determining the effectiveness of the campaign advertisement.

FIG. 5 shows an example of a campaign advertisement report generated by a report generator.

FIG. 6 shows an example of a computer device and a mobile computer device that can be used to implement the techniques described herein.

Like reference symbols in the various drawings indicate like elements.

### DETAILED DESCRIPTION

Described herein is a system that tests pointers to information to determine whether the information (that was referenced by the pointer) was accessed directly or indirectly by a user of the system. Generally, the term “pointers” includes a reference that directs a user to information. For example, pointers include both physical pointers (e.g., coupons) and virtual pointers (e.g., Hyper Text Mark-up Language (“HTML”) links). In another example, a pointer includes a campaign advertisement, because the campaign advertisement directs a consumer to store, a website, or other venue from which the consumer may purchase the good and/or service that was featured in the campaign advertisement. In an example, pointers to information include pointers to measurable goals (e.g., conversions).

In an example, the system may compare the effectiveness of one advertisement campaign to another advertisement campaign and/or groups of control advertisements to groups of campaign advertisements. In another example, the system may test user interface features to determine an impact of the user interface features on a user.

In yet another example, the system may determine whether a campaign advertisement impacts a number of conversions, for example, for a product and/or a service that is the subject of the campaign advertisement. However, an advertiser may define a conversion in numerous ways, including, e.g., as an increase in consumers' visits to a website that is associated with the campaign advertisement. In still another example, a conversion includes submission of email addresses.

The following examples are provided with regard to a campaign advertisement, except where otherwise indicated. However, it is to be understood that the processes and techniques described herein are equally applicable to any type of pointer to determine an impact of the pointer.

The system determines the effectiveness of the campaign advertisement by using a “test group” of consumers and a “control group” of consumers. The test group includes a group of consumers that are exposed to the campaign advertisement, for example, by viewing the campaign advertisement on websites and/or through email messages. In an example, the control group includes a group of consumers that are exposed to a “control advertisement,” rather than the campaign advertisement. A control advertisement includes an advertisement that is not related to the campaign advertisement. For example, a control advertisement may include an advertisement for a charity.

In another example, the control group includes a group of consumers that are exposed to the control advertisement and a group of consumers that are not exposed to the control advertisement, because exposure to the control advertisement has been suppressed for some consumers. In this example, campaign advertisements are shown to “test users” (e.g., users in the test group), but campaign advertisements are not shown to “control users” (e.g., users in the control group). However, some advertisements for another campaign may be shown. By suppressing control advertisements, experiment's “unnecessary” costs are reduced. Additionally, suppression of the control advertisements also reduces a need to generate the control advertisement.

In an example, the system runs an auction to decide which advertisements to show alongside search results. For control users, it might not include the campaign advertisement in the auction. However, the system records when the campaign advertisement, if it were included in the auction, would have been shown.

In yet another example, the control group includes a group of consumers that are not exposed to the campaign advertisement.

The system exposes the test group to the campaign advertisement and the control group to the control advertisement. In response to the test group viewing the campaign advertisement and the control group viewing the control advertisement, the system tracks “conversion information.” Generally, conversion information includes information that relates to conversions, including, e.g., a total number of conversions, a number of conversions that are attributable to the campaign advertisement, and a number of conversions that are attributable to the control advertisement (e.g., “control conversions”). Control conversions may be assumed to be representative of naturally occurring conversions in a test group. In an example, the system determines the effectiveness of the campaign advertisement by determining a portion of the total number of conversions that are attributable to the campaign advertisement.

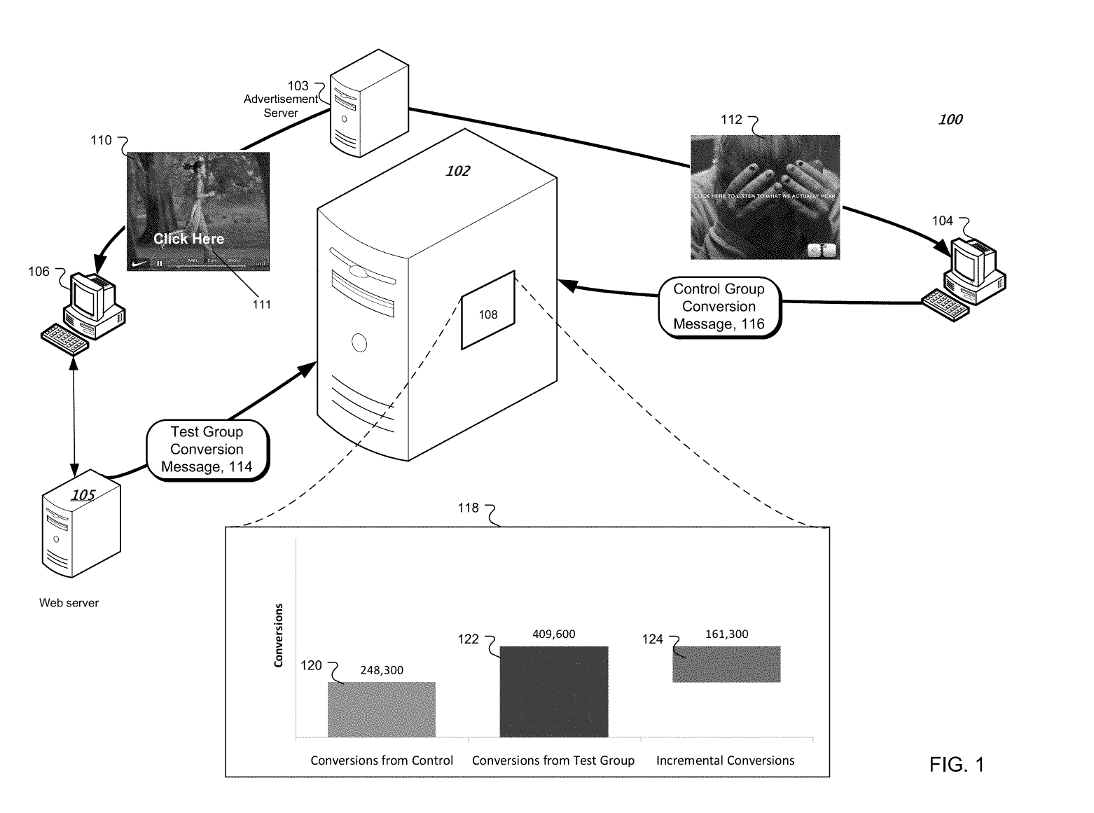

FIG. 1 is a conceptual diagram of system 100 for determining an effectiveness of a campaign advertisement. System 100 includes server 102, advertisement server 103, web server 105 and client devices 104, 106. Server 102 includes campaign manager 108, which is configured to determine the effectiveness of the campaign advertisement.

In the example of FIG. 1, campaign advertisement 110 is a campaign advertisement for athletic apparel. Control advertisement 112 is a control advertisement for a relief group that provides assistance to hurricane victims. Client device 106 is associated with a test group. Client device 106 receives campaign advertisement 110 from advertisement server 103, which may be associated with a third-party server that is configured to serve campaign advertisements. In the example of FIG. 1, the serving of campaign advertisements is independent from the collection of “conversion information” (e.g., information specifying a conversion) and the measurement of attribution statistics, such as an incremental conversion rate.

In the example of FIG. 1, client device 104 is associated with a control group. Client device 104 receives control advertisement 112 from advertisement server 103.

A consumer (not shown) associated with client device 106 views campaign advertisement 110 on client device 106. In response to viewing campaign advertisement 110, the consumer makes a conversion by purchasing the athletic apparel that is advertised in campaign advertisement 110. In the example of FIG. 1, campaign advertisement 110 includes link 111. The consumer may select link 111 to initiate a purchase of the athletic apparel that is advertised in campaign advertisement 110. For example, a selection of link 111 may direct the consumer to another website hosted by web server 105 that sells the athletic apparel that is advertised in campaign advertisement 110. That is, web server 105 may host web pages through which the consumer may make a conversion.

When the consumer associated with client device 106 makes the conversion by purchasing the athletic apparel that is advertised in campaign advertisement 110, test group conversion message 114 is sent to server 102, for example, by web server 105 through which the conversion was made. Test group conversion message 114 includes conversion information, including, e.g., information specifying an identity (e.g., an internet protocol (“IP”) address) of client device 106, information specifying that the consumer associated with client device 106 has viewed campaign advertisement 110, and so forth.

Server 102 receives test group conversion message 114 and stores the conversion information included in test group conversion message 114. Server 102 also recodes and/or other marks displays of campaign advertisement 110 that failed to lead to a conversion. That is, server 102 maintains a record of every display of campaign advertisement 110. By matching the received test group conversion messages to the numerous displays of campaign advertisement 110, server 102 is able to determine which displays of campaign advertisement 110 failed to generate a conversion.

In the example of FIG. 1, advertisement server 103 also sends control advertisement 112 to client device 104, which is associated with the control group. A consumer associated with client device 104 views control advertisement 112. Control advertisement 112 is a control advertisement that does not promote the athletic apparel that is the subject of the campaign advertisement 110. Rather, as described above, control advertisement 112 includes an advertisement for a relief group.

After viewing control advertisement 112, the consumer makes a conversion by purchasing the athletic apparel that is advertised in campaign advertisement 110. However, the consumer's conversion is not attributable to campaign advertisement 110, because the consumer has not viewed campaign advertisement 110. Rather, the consumer has viewed control advertisement 112 and has independently chosen to purchase the athletic apparel that is the subject of campaign advertisement 110. That is, even though control advertisement 112 does not include a reference to the athletic apparel, the consumer has independently chosen to purchase the athletic apparel.

In this example of FIG. 1, when the consumer associated with client device 104 makes the conversion, control group conversion message 116 is sent to server 102 by client device 104. In this example, the consumer makes the conversion in an “on-line state”, for example, by accessing a web page hosted by web server 105 and making the conversion through the web page.

In another example, web server 105 sends control group conversion message 116 to server 102, for example, when the consumer makes the conversion in an “off-line state”. In this example, the consumer makes the conversion through a land-line telephone. Because the consumer's land-line telephone may not be capable of sending control group conversion message 116, web server 105 sends control group conversion message 116 to server 102.

Control group conversion message 116 includes conversion information specifying an identity (e.g., an internet protocol (“IP”) address) of client device 104, information specifying that the consumer associated with client device 104 viewed control advertisement 112, and so forth. Server 102 receives control group conversion message 116 and stores the conversion information included in control group conversion message 116.

Server 102 receives test group conversion messages (e.g., test group conversion message 114) and control group conversion messages (e.g., control group conversion message 116) from numerous client devices, including, client devices 104, 106. Based on the test group conversion messages and the control group conversion messages, campaign manager 108 determines numerous statistics associated with campaign advertisement 110, as described in further detail below.

In an example, conversion messages are not labeled as a test group conversion message or as a control group conversion message. Rather, the conversion message includes no indication of whether a user is associated with the control group or with the test group. In this example, a conversion map, as described in detail herein, is applied to information included in the conversion message to determine whether a conversion is associated with the test group or with the control group.

In the example of FIG. 1, campaign manager 108 generates campaign advertisement report 118. Campaign advertisement report 118 includes information 120, which specifies a number of conversions from the control group. The number of conversions from the control group includes information specifying a number of conversions that are attributable to control advertisement 112. That is, information 120 is indicative of “naturally occurring conversions,” including, e.g., conversions that would have occurred without campaign advertisement 110. Naturally occurring conversions may include, but is not limited to, the following types of conversions. First, a member of the control group views control advertisement 112 and subsequent to the viewing of control advertisement 112 makes a conversion. Second, a consumer views no advertisement (e.g., control advertisement 112 and/or campaign advertisement 110) and makes the conversion entirely independent of any advertisement.

Campaign advertisement report 118 also includes information 122, which specifies a number of conversions that are attributable to the test group that viewed campaign advertisement 110. In the example of FIG. 1, some of the conversions that are attributable to the test group are naturally occurring conversions. That is, some of the consumers who made a conversion after viewing campaign advertisement 110 would have made the conversion even if they had not viewed campaign advertisement 110. However, some of the consumers made the conversion only as a result of viewing campaign advertisement 110. The number of conversions made as a result of viewing campaign advertisement 110 may be referred to as “incremental conversions.” That is, the term incremental conversions includes conversions that would not have occurred but for campaign advertisement 110. Campaign advertisement report 118 also includes information 124 specifying a number of incremental conversions.

In the example of FIG. 1, campaign manager 108 determines an incremental conversion rate by subtracting a natural conversion rate (e.g., a rate of conversions for the control group and/or other naturally occurring conversions) from a rate of conversions for the test group. By determining an incremental conversion rate, campaign manager 108 is effectively able to weight the conversions by taking into account a number of times an advertisement was displayed to the test group and/or to the control group.

In another example, campaign manager 108 determines an absolute number of conversions. In this example, information 120, e.g., specifies that 248,300 conversions naturally occurred without consumers being exposed to campaign advertisement 110. Information 112, e.g., specifies that 409,600 conversions are attributable to campaign advertisement 110. Information 124 specifies, e.g., that 161,300 incremental conversions occurred due to campaign advertisement 110. That is, of the 409,600 conversions that are attributable to campaign advertisement 110, 248,300 of the conversions are presumed to have naturally occurred. Therefore, campaign advertisement 110 drove an additional 161,300 incremental conversions.

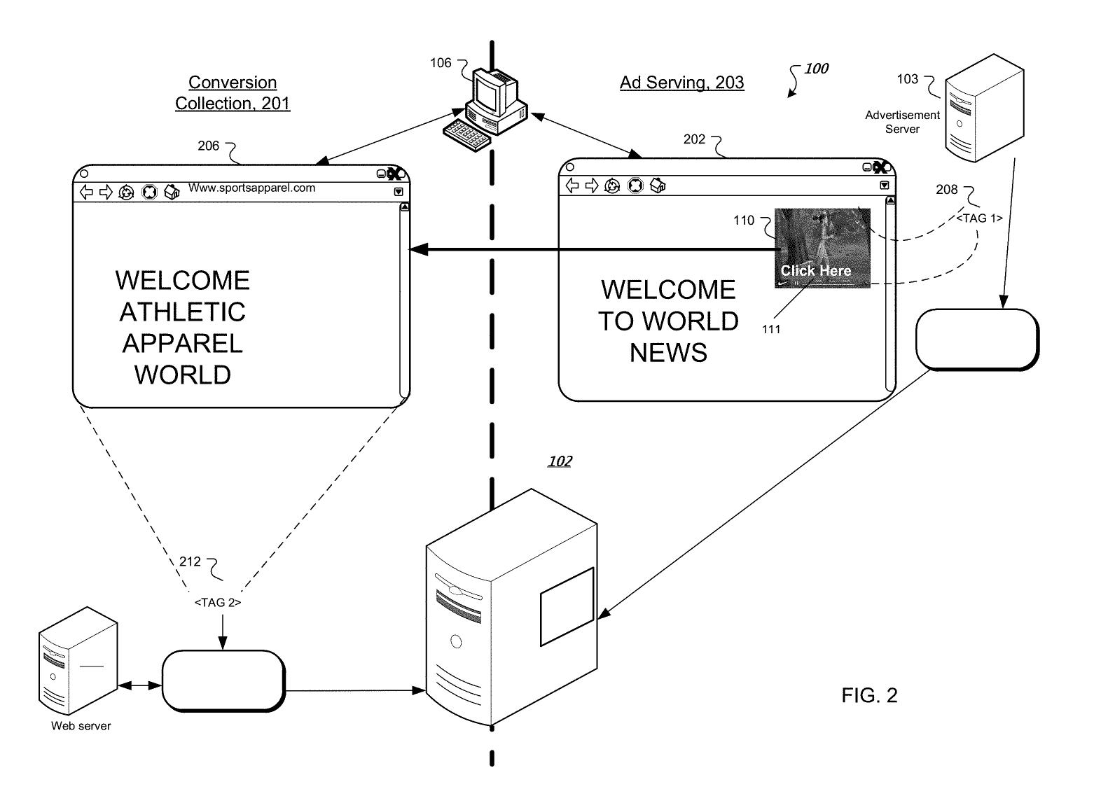

FIG. 2 is a conceptual diagram of how system 100 determines whether a conversion is attributable to campaign advertisement 110. FIG. 2 is broken into two parts, a left part, 201 and a right part, 203. Left part 201 includes parts of system 100 that may be related to conversion collection, including, e.g., collecting from web server 105 and/or from client device 106 information related to a conversion. Right part 203 includes parts of system 100 that may be related to advertisement serving by advertisement 203.

In the example of FIG. 2, left part 201 may be separate and independent from right part 203, representing that conversion collection is independent from ad serving. As described in further detail below, campaign manager 108 receives and uses the information related to conversions and the information related to ad serving to determine an impact of an advertisement campaign or more generally determine whether pointers were accessed directly or indirectly.

In the example of FIG. 2, Tags 208, 212 that may be inserted into websites to track a consumer's viewing of campaign advertisements and/or to track conversions made by a consumer. Tags 208, 212 may be generated by a website from which a conversion may be made, by an independent system, by server 102, or by an entity that is running a marketing campaign.

In the example of FIG. 2, campaign advertisement 110 is displayed in website 202, which is associated with a Uniform Resource Location (“URL”) of “sportsapparel.com.” Campaign advertisement 110 is sent to client device 106 by advertisement server 103. Campaign advertisement 110 includes tag 208. Tag 208 includes instructions specifying information to be sent to server 102 when campaign advertisement 110 is downloaded to client device 106 and/or is served by advertisement server 103. For example, tag 208 may include a cookie that determines an address or other identifying information associated with client device 106.

In another example, when advertisement server 103 serves campaign advertisement 110, advertisement server 103 generates tracking message 210, for example. A tracking message is a message that identifies an address (e.g., an IP address) of a client device that has displayed a campaign advertisement. A tracking message may also include information specifying a type of campaign advertisement that has been viewed by a consumer. A tracking message may include the following format: {IP address of client device that displays campaign advertisement, type of campaign advertisement displayed}.

In the example of FIG. 2, when client device 106 sends a request for an advertisement from advertisement server 103, the request includes information that uniquely identifies a user associated with the client device. When advertisement server 103 serves campaign advertisement 110 to client device 106, advertisement server also sends to server 102 a record of the serving of the campaign advertisement to client device. The record of the serving of the campaign advertisement also includes identifying information associated with client device 106. Identifying information may include a cookie, an IP address, and any other type of information that is able to uniquely identify client device 106.

In an example, advertisement server 103 uses cookie tracking to identify a client device that has requested an advertisement campaign. However, advertisement server 103 could use numerous other techniques to identify a client device, including, e.g., using an IP address associated with the client device.

In another example, humans are tracked using the techniques described here. For example, a human may use a login ID from multiple computers. Using the human's login ID, the system is able to determine whether the human is associated with the test group or with the control group.

In another example, advertisement server 103 determines that client device 106 is associated with an IP address of “10.1.1.1”. Advertisement server 103 generates tracking message 210, which includes the following information: {10.1.1.1, campaign advertisement 110}. That is, tracking message 210 specifies that client device 106 is associated with an IP address of “10.1.1.1” and the type of advertisement displayed by client device 106 is a campaign advertisement, namely, campaign advertisement 110. Tracking message 210 is sent to server 102. From the information included in tracking message 210, campaign manager 108 determines that campaign advertisement 110 was displayed on client device 106, which is associated with an IP address of “10.1.1.1”.

As previously described, campaign advertisement 110 includes link 111. In the example of FIG. 2, when a consumer selects link 111, the consumer is directed to web page 206, which is hosted by web server 105. In another example, a user may convert via direct navigation to information, rather than clicking on a link or other pointer.

Web page 206 includes “conversion pages.” Generally, a conversion page includes a web page through which a consumer may make a conversion. Through web page 206, the consumer may make a conversion, for example, by purchasing the athletic apparel that is advertised in campaign advertisement 110.

Web page 206 also includes tag 212. In this example, client device 106 downloads web page 206, which causes an execution of tag 212. When the consumer associated with client device 106 initiates a conversion, tag 212 generates test group conversion message 114. Test group conversion message 114 may include the following format: {IP address of client device from which conversion is made, name of website from which conversion is made}.

In the example of FIG. 2, test group conversion message 114 includes the following information: {10.1.1.1, sportsapparel.com}. Client device 106 sends test group conversion message 114 to server 102. Server 102 receives the test group conversion message 114. Campaign manager 108 matches the IP address (e.g., “10.1.1.1”) included in tracking message 210 to the IP address e.g., (“10.1.1.1”) included in test group conversion message 114. By matching the IP addresses, campaign manager 108 determines that the consumer associated with client device 106 viewed campaign advertisement 110 and made a conversion by purchasing athletic apparel that was advertised in campaign advertisement 110. Accordingly, campaign manager 108 determines that the conversion by the consumer associated with client device 106 is attributable to campaign advertisement 110.

In a variation of FIG. 2, rather than including campaign advertisement 110, website 202 includes control advertisement 112 and is displayed on client device 104. In this example, tag 208 is included in control advertisement 112, rather than in campaign advertisement 110. Accordingly, tag 208 generates a tracking message, which includes the following information: {10.1.1.2, control advertisement 112}. That is, the tracking message specifies that client device 104 is associated with an IP address of “10.1.1.2” and that control advertisement 112 is displayed on client device 104. The tracking message is sent to server 102.

At some time after the consumer associated with client device 104 has viewed control advertisement 112, the consumer makes a conversion, for example, by navigating to web page 206 and purchasing athletic apparel that was advertised in campaign advertisement 110. When the consumer makes the conversion, tag 212 generates control group conversion message 116, which includes the following information: {10.1.1.2, sportsapparel.com}. Client 104 sends control group conversion message 116 to server 102.

Campaign manager 108 matches the IP address (e.g., “10.1.1.2”) included in the tracking message to the IP address (e.g., “10.1.1.2”) included in control group conversion message 116. By matching the IP addresses, campaign manager 108 determines that the consumer associated with client device 104 viewed control advertisement 112 and made a conversion by purchasing athletic apparel that was advertised in campaign advertisement 110. Accordingly, campaign manager 108 determines that the conversion made by the consumer associated with client device 104 is attributable to control advertisement 112, rather than campaign advertisement 110. In an example, when a conversion is attributable to control advertisement 112, the conversion is independent of campaign advertisement 110.

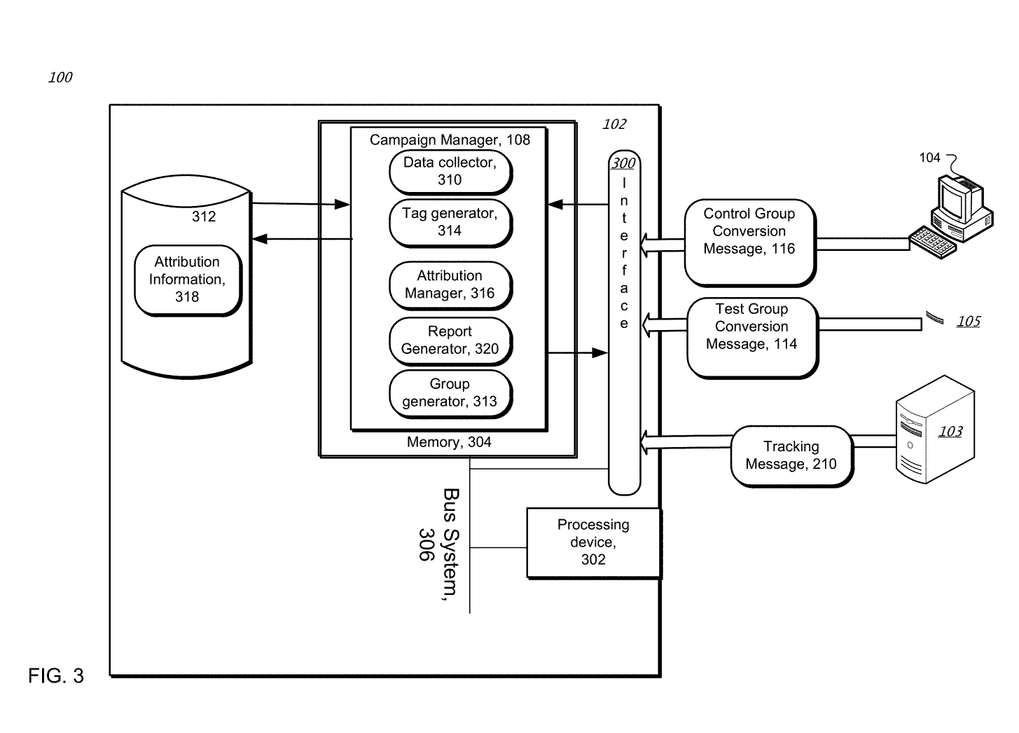

FIG. 3 is a block diagram of components of system 100 for determining the effectiveness of campaign advertisement 110. Client devices, 104, 106 (not shown) can be any sort of computing devices capable of taking input from a user and communicating over a network (not shown) with server 102 and/or with other client devices. For example, client devices 104, 106 can be mobile devices, desktop computers, laptops, cell phones, personal digital assistants (“PDAs”), servers, embedded computing systems, and so forth. Servers 102, 103, 105 can be any of a variety of computing devices capable of receiving information, such as a server, a distributed computing system, a desktop computer, a laptop, a cell phone, a rack-mounted server, and so forth. Server 102 may be a single server or a group of servers that are at a same location or at different locations. Servers 103, 105 may also be a single server or a group of servers that are at a same location or at different locations.

Server 102 can receive information from client devices 104, 106 via input/output (“I/O”) interface 300. I/O interface 300 can be any type of interface capable of receiving information over a network, such as an Ethernet interface, a wireless networking interface, a fiber-optic networking interface, a modem, and so forth. Server 102 also includes a processing device 302 and memory 304. A bus system 306, including, for example, a data bus and a motherboard, can be used to establish and to control data communication between the components of server 102.

Processing device 302 may include one or more microprocessors. Generally speaking, processing device 302 may include any appropriate processor and/or logic that is capable of receiving and storing data, and of communicating over a network (not shown). Memory 304 can include a hard drive and a random access memory storage device, such as a dynamic random access memory, or other types of non-transitory machine-readable storage devices. As shown in FIG. 3, memory 304 stores computer programs that are executable by processing device 302. Among these computer programs are data collector 310, group generator 313, tag generator 314, attribution manager 316, and report generator 320, each of which are described in further detail below.

In the example of FIG. 3, campaign manager 108 includes group generator 313, which is configured to generate a target group and a control group for campaign advertisement 110. In an example, group generator 313 determines a group of users that are associated with a control group and another group of users that are associated with the test group. In this example, group generator 313 identifies users based on a cookie associated with a computing device that is used by a user. Group generator 313 may access a list of cookies, where each cookie corresponds to a user. Group generator 313 generates a control group of users and a test group of users by dividing up the list of cookies.

In an example, group generator 313 divides the list up such that the test group includes ⅔ of the users in the list and the control group includes ⅓ of the users in the group, or vice versa. Group generator 313 generates a conversion map, as described in further detail below, that tracks whether a particular user is associated with the control group or with the test group. As campaign manager 108 receives campaign advertisement information and conversion information, campaign manager 108 uses the conversion map to determine whether campaign advertisement information and/or conversion information is attributable to the test group or to the control group. In an example, group generator 313 generates a graphical user interface (“GUI’) that allows a marketer to select and/or to enter into the system an appropriate percentage of users for the control group and an appropriate percentage of users for the test group.

In another example, group generator 313 receives from an advertiser (not shown) information specifying the names of websites on which the advertiser wants to display a campaign advertisement. The names of the websites may be website 1, website 2, website 3, website 4, . . . , website 10. Group generator 313 determines that websites 1-5 are associated with a control group and that websites 6-10 are associated with a test group. Accordingly, group generator 313 assigns campaign advertisement 110 to websites 6-10 and control advertisement 112 to websites 1-5. Group generator 313 may notify the advertiser of the assignment of campaign advertisement 110 to websites 6-10 and the assignment of control advertisement 112 to websites 1-5 to enable the advertiser to configure its placement of campaign advertisements and control advertisements accordingly.

Campaign manager 108 also includes data collector 310, which is configured to save in data repository 312 information included in test group conversion message 114, control group conversion message 116, and tracking message 210. In an example, data collector 310 parses a test group conversion message to determine the IP address of a client device from which a conversion was made and a name of a website from which the conversion was made. Specifically, data collector 310 parses test group conversion message 114 to retrieve an IP address of client device 106, namely, “10.1.1.1”, and a name of the website from which client device 106 made the conversion, namely, “sportsapparel.com.” Data collector 310 saves the retrieved information of “10.1.1.1” and “sportsapparel.com” in a table in data repository 312.

Web server 105 and advertisement server 103 may include a tag generator to generate tags 208, 212. Additionally, as previously addressed, tags 208, 212 may be generated by an independent entity. In these examples, a tag generator used by the independent entity separate and independent from campaign manager 108.

In a variation, campaign manager 108 also includes tag generator 314, which is configured to generate tags 208, 212 for insertion into campaign advertisement 110, control advertisement 112, and/or web page 206. As described above, through tags 208, 212, campaign manager 108 is able to track the campaign advertisements and control advertisements that have been displayed on a particular client device and the conversions that have been made from the particular client device.

Campaign manager 108 also includes attribution manager 316, which is configured to match address information included in test group conversion message 114 and/or control group conversion message 116 to address information included in tracking message 210. Tracking message 210 includes campaign advertisement information, including, e.g., an identifier of a client device to which the campaign advertisement was served, the time the advertisement was served, and whether the advertisement was a control advertisement or a campaign advertisement. Conversion messages 114, 116 include conversion information, including, e.g., an identifier of a client device making the conversion, a type of conversion that was made, and the time the conversion was made. Additionally, as previously described, the conversion information and the campaign advertisement information may be sent from independent systems, namely, a web server (e.g., web server 105) from which the conversion was made and an advertisement server (e.g., advertisement server 103).

As described herein, attribution manager 316 is configured to match the conversion information with the campaign advertisement information. In an example, attribution manager 316 matches the conversion information and the campaign advertisement information by matching the relative identifiers in the conversion information and in the campaign advertisement information. Based on the matching, attribution manager 316 determines which users saw which advertisements. For example, based on the matching, attribution manager 316 matches a particular user, as identified by an identifier of a client device associated with the user, to a particular advertisement.

Based on a conversion map, which is described in further detail below, attribution manager determines whether the user is a user in the control group or in the test group. Based on an assessment of whether the user is in the control group or in the test group, attribution manager 316 is then able to determine whether the user viewed a control advertisement or a campaign advertisement, and whether the conversion is attributable to the control advertisement, to the campaign advertisement or is naturally occurring.

Attribution manager 316 is also configured to filter out conversion information that may be inaccurate. Filtering reduces the possibility that control users have been exposed to an advertisement campaign. In an example, filtering is used to promotion the integrity of control and test groups. In this example, attribution manager 316 filters out IP tracked users, in case of dynamic IP assignment. Attribution manager 316 also filters out ‘young’ cookies, in case users have recently flushed cookies.

Attribution manager 316 may also retrieve from data repository 312 a “conversion map.” In an example, a conversion map includes a mapping of users to a test group or to a control group. Attribution manager 316 uses the conversion map to determine whether conversion information and campaign advertisement information is attributable to a user in the test group or to a user in the control group. Based on a determination of whether conversion information and campaign advertisement information is attributable to a user in the test group or to a user in the control group, attribution manager 316 may determine whether a conversion itself is attributable to a campaign advertisement, to a control advertisement, or is a naturally occurring conversion.

In another example, a conversion map includes a mapping of website names to a particular campaign advertisement. In an example, a conversion map specifies that web page 206 is associated with campaign advertisement 110. That is, campaign advertisement 110 directs consumers to web page 206.

In an example, attribution manager 316 retrieves from data repository 312 information included in tracking message 210, namely, {10.1.1.1, campaign advertisement 110}. Attribution manager 316 also retrieves from data repository 312 information included in test group conversion message 114, namely {10.1.1.1, sportsapparel.com}, as described above.

In this example, attribution manager 316 determines that the IP address (e.g., “10.1.1.1”) included in test group conversion message 114 matches the IP address (e.g., “10.1.1.1”) included in tracking message 210. Accordingly, attribution manager 316 determines that the client device (e.g., client device 106) associated with the matching IP addresses (e.g., “10.1.1.1”) both displayed campaign advertisement 110 and was used for the conversion specified by test group conversion message 114. Additionally, based on the conversion map, attribution manager 316 also determines that web page 206 is associated with campaign advertisement 110. Accordingly, attribution manager 316 determines that the conversion specified by test group conversion message 114 is attributable to campaign advertisement 110.

In another example, attribution manager 316 determines that the IP address (e.g., “10.1.1.2”) included in control group conversion message 116 matches the IP address (e.g., “10.1.1.2”) included in a tracking message. Accordingly, attribution manager 316 determines that the client device (e.g., client device 104) associated with the matching IP addresses (e.g., “10.1.1.2”) both displayed control advertisement 112 and was used for the conversion specified by control group conversion message 116. However, in this example, the conversion map does not include a mapping of web page 206 to control advertisement 112. Accordingly, attribution manager 316 determines that web page 206 is not associated with control advertisement 112 and that the conversion is a naturally occurring conversion.

Attribution manager 316 stores, in data repository 312, “attribution information” 318. Attribution information includes information that specifies whether a particular conversion is a naturally occurring conversion or is attributable to a campaign advertisement. Attribution manager 316 is also configured to determine a fraction of naturally occurring conversions among the test conversions (e.g., conversions that are not attributable to campaign advertisement), including, e.g., conversions that are attributable to campaign advertisement 110 but would have occurred even in an absence of campaign advertisement 110. In an example, attribution manager 316 may determine this information based on a measured rate of naturally occurring conversions. That is, the rate of naturally occurring conversions is applied to the number of test conversions to determine the number of test conversions that are actually naturally occurring conversions.

In an example, attribution manager 316 stores in data repository 312 attribution information 318 indicating that the conversion specified by test group conversion message 114 is attributable to campaign advertisement 110. In another example, attribution manager 316 stores in data repository 312 attribution information 318 indicating that the conversion specified by control group conversion message 114 is a naturally occurring conversion.

Campaign manager 108 also includes report generator 320, which is configured to retrieve attribution information 318 from data repository 312 and to execute statistical rules to generate a report (e.g., campaign advertisement report 118) from attribution information 318.

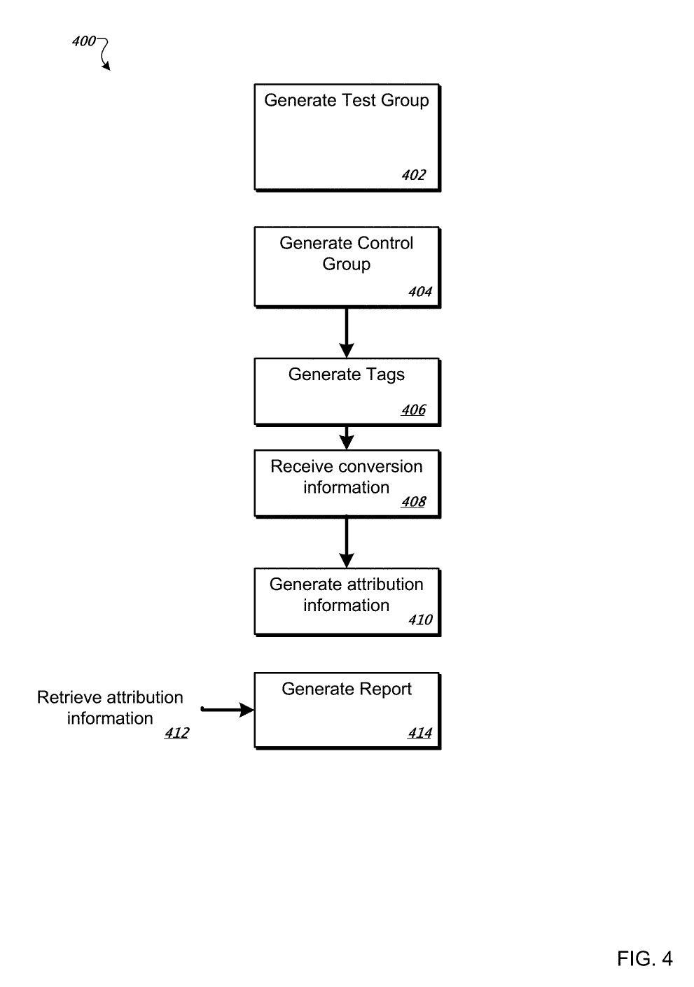

FIG. 4 is a flowchart of process 400 performed by campaign manager 108 for determining the effectiveness of campaign advertisement 110. In operation, group generator 313 generates (402) a test group and generates (404) a control group. Tag generator 314 generates (406) tags (e.g., tags 208, 212) that are inserted into various control advertisements, campaign advertisements and conversion pages. Data collector 310 receives (408) conversion information, for example, from test group conversion message 114, control group conversion message 116, and tracking message 210. Data collector 310 stores (not shown) the conversion information in data repository 312.

Attribution manager 316 retrieves (not shown) the conversion information from data repository 312 and generates (410) attribution information 318 based on the conversion information. Report generator 320 retrieves (412) attribution information 312 from data repository 312 and generates (414) a report based on the retrieved attribution information 318.

Attribution manager 316 may also be configured to determine numerous types of “derivative information”, including, e.g., information that is derived from attribution information 318. As described below, derivative information includes information specifying a “frequency of exposure” (e.g., an optimal frequency of exposure, an incremental effect of an additional exposure to a campaign advertisement, and an optimal number of exposures for the campaign advertisement) and information specifying “an impact of an advertising budget reduction on a number of incremental conversions.”

Generally, a “frequency of exposure” includes a number of times a campaign advertisement should be displayed to a group of consumers to effectively convey a message in the campaign advertisement to the group of consumers. To determine a frequency of exposure, campaign manager 108 may define a conversion as a consumer's visit to a website, for example, when a goal of a campaign advertisement is to drive consumers to the website.

To calculate the frequency of exposure, attribution manager 316 uses the techniques described herein to determine attribution information, namely, a number of naturally occurring visits to the website, a number of visits to the website that are attributable to the campaign advertisement, and a number of incremental visits to the website. Attribution manager 316 may combine the attribution information with other information related to the campaign advertisement, including, e.g., a number of times consumers were exposed to the campaign advertisement, to determine a frequency of exposure. In an example, attribution manager 316 may determine a frequency of exposure by generating a linear regression between a number of times consumers were exposed to the campaign advertisement and a number of incremental visits to the website.

Attribution manager 316 may also calculate an impact of an advertising budget reduction on a number of incremental conversions. For example, attribution manager 316 may determine that an advertising budget reduction results in a campaign advertisement being displayed to consumers less frequently. Using the linear regression described above, attribution manager 316 may determine by how much the number of incremental conversions will decrease based on the decreased display of the campaign advertisement.

Attribution manager 316 may also calculate an impact of a campaign advertisement on a volume of advertiser-related search queries. For example, a conversion may be defined as a consumer conducting a search for a particular advertiser. In this example, a campaign advertisement repeatedly mentions the name of the advertiser. A test group is exposed to the campaign advertisement, and a control group is exposed to a control advertisement, for example, control advertisement 112. Using the techniques described herein, attribution manager 316 determines an incremental number of advertiser-related search queries that are attributable to the campaign advertisement.

Attribution manager 316 is also configured to determine attribution information for a “conversion group.” Generally, a conversion group includes a number of conversions that are related to each other, for example, because the conversions are all of a same type. In an example, attribution manager 316 tracks conversions for running shoes, windbreakers, running shorts, and running shirts. In this example, running shoes, windbreakers, running shorts, and running shirts are all a type of athletic apparel. Accordingly, attribution manager 316 generates an “athletic apparel” conversion group, which includes conversion information for conversions related to running shoes, windbreakers, running shorts, and running shirts. Attribution manager 316 generates attribution information related to individual conversions for running shoes, windbreakers, running shorts, and running shirts. For example, attribution manager 316 may determine a number of incremental conversions for running shoes that is attributable to a campaign advertisement for running shoes.

In this example, attribution manager 316 also generates attribution information for the athletic apparel conversion group. Specifically, attribution information for the athletic apparel conversion group may include a number of incremental conversions for athletic apparel that is attributable to campaign advertisements for athletic apparel, namely, campaign advertisements for running shoes, windbreakers, running shorts, and running shirts.

Attribution manager 316 is also configured to determine numerous types of incremental conversions, for example, based on information included in tags 208, 212. For example, attribution manager 316 may determine whether an incremental conversion is an “incremental view-through conversion.” Generally, an “incremental view-through conversion” includes an incremental conversion that resulted from a consumer viewing a campaign advertisement and making a conversion. Referring back to FIG. 2, an incremental view-through conversion is made when a consumer views campaign advertisement 110, does not click on link 111, but at another point in time visits web page 206 to make a conversion.

In another example, an incremental conversion may be an “incremental click-through conversion.” Generally, an “incremental click-through conversion” includes an incremental conversion that results from a consumer viewing a campaign advertisement, selecting a link included in the campaign advertisement, and making a conversion following the selection of the link. Referring back to FIG. 2, an incremental click-through conversion is made when a consumer selects link 111 in campaign advertisement 110, is directed to web page 206, as a result of the selection of link 111, and makes a conversion through web page 206.

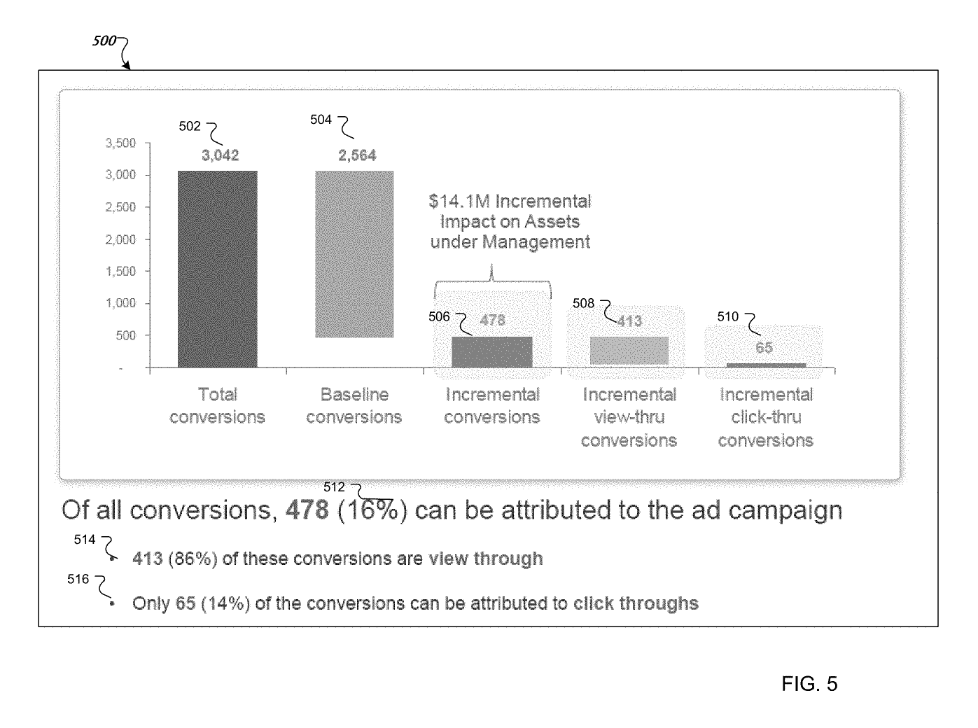

FIG. 5 shows an example of campaign advertisement report 500 generated by report generator 320. Campaign advertisement report 500 includes information 502 specifying a total number of conversions, information 504 specifying a number of naturally occurring conversions, information 506 specifying a number of incremental conversions, information 508 specifying a number of incremental view-through conversions, and information 510 specifying a number of incremental click-through conversions. In the example of FIG. 5, report generator 320 determines information 506 specifying the number of incremental conversions by subtracting information 504 specifying a number of naturally occurring conversions from information 502 specifying a total number of conversions.

Report generator 320 is also configured to calculate a relative number of incremental conversions. In the example of FIG. 5, campaign advertisement report 500 includes information 512 specifying that 16% of conversions are incremental conversion. In this example, report generator 320 determined information 512 based on a ratio of information 506 specifying a number of incremental conversions to information 502 specifying a total number of conversions.

Campaign advertisement report 500 also includes information specifying a relative number and an absolute number of the incremental conversions that are incremental view-through conversions and a relative number and an absolute number of the incremental conversions that are incremental click-through conversions. Specifically, campaign advertisement report 500 includes information 514 specifying that four hundred thirteen or 86% of the incremental conversions are incremental view-through conversions. Campaign advertisement report 500 also includes information 516 specifying that sixty-five or 14% of the incremental conversions are incremental click-through conversions.

Using the techniques described herein, a control group and a test group are used to determine the effectiveness of a campaign advertisement.

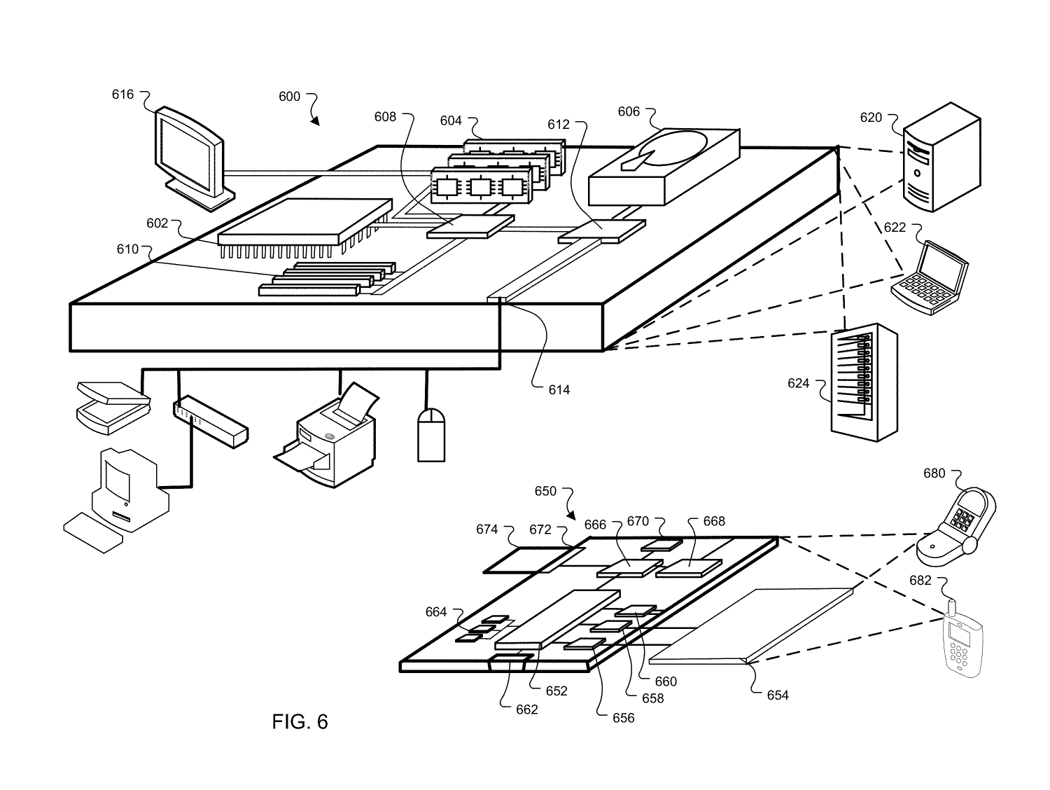

FIG. 6 shows an example of a computer device 600 and a mobile computer device 650, which may be used with the techniques described here. Computing device 600 is intended to represent various forms of digital computers, such as laptops, desktops, workstations, personal digital assistants, servers, blade servers, mainframes, and other appropriate computers. Computing device 650 is intended to represent various forms of mobile devices, such as personal digital assistants, cellular telephones, smartphones, and other similar computing devices. The components shown here, their connections and relationships, and their functions, are meant to be examples only, and are not meant to limit implementations of the techniques described and/or claimed in this document.

Computing device 600 includes a processor 602, memory 604, a storage device 606, a high-speed interface 608 connecting to memory 604 and high-speed expansion ports 610, and a low speed interface 612 connecting to low speed bus 614 and storage device 606. Each of the components 602, 604, 606, 608, 610, and 612, are interconnected using various busses, and may be mounted on a common motherboard or in other manners as appropriate. The processor 602 can process instructions for execution within the computing device 600, including instructions stored in the memory 604 or on the storage device 606 to display graphical information for a GUI on an external input/output device, such as display 616 coupled to high speed interface 608. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 604 stores information within the computing device 600. In one implementation, the memory 604 is a volatile memory unit or units. In another implementation, the memory 604 is a non-volatile memory unit or units. The memory 604 may also be another form of computer-readable medium, such as a magnetic or optical disk.

The storage device 606 is capable of providing mass storage for the computing device 600. In one implementation, the storage device 606 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 604, the storage device 606, memory on processor 602, or a propagated signal.

The high speed controller 608 manages bandwidth-intensive operations for the computing device 600, while the low speed controller 612 manages lower bandwidth-intensive operations. Such allocation of functions is an example only. In one implementation, the high-speed controller 608 is coupled to memory 604, display 616 (e.g., through a graphics processor or accelerator), and to high-speed expansion ports 610, which may accept various expansion cards (not shown). In the implementation, low-speed controller 612 is coupled to storage device 606 and low-speed expansion port 614. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 620, or multiple times in a group of such servers. It may also be implemented as part of a rack server system 624. In addition, it may be implemented in a personal computer such as a laptop computer 622. Alternatively, components from computing device 600 may be combined with other components in a mobile device (not shown), such as device 650. Each of such devices may contain one or more of computing device 600, 650, and an entire system may be made up of multiple computing devices 600, 650 communicating with each other.

Computing device 650 includes a processor 652, memory 664, an input/output device such as a display 654, a communication interface 666, and a transceiver 668, among other components. The device 650 may also be provided with a storage device, such as a microdrive or other device, to provide additional storage. Each of the components 650, 652, 664, 654, 666, and 668, are interconnected using various buses, and several of the components may be mounted on a common motherboard or in other manners as appropriate.

The processor 652 can execute instructions within the computing device 650, including instructions stored in the memory 664. The processor may be implemented as a chipset of chips that include separate and multiple analog and digital processors. The processor may provide, for example, for coordination of the other components of the device 650, such as control of user interfaces, applications run by device 650, and wireless communication by device 650.

Processor 652 may communicate with a user through control interface 658 and display interface 656 coupled to a display 654. The display 654 may be, for example, a TFT LCD (Thin-Film-Transistor Liquid Crystal Display) or an OLED (Organic Light Emitting Diode) display, or other appropriate display technology. The display interface 656 may comprise appropriate circuitry for driving the display 654 to present graphical and other information to a user. The control interface 658 may receive commands from a user and convert them for submission to the processor 652. In addition, an external interface 662 may be provide in communication with processor 652, so as to enable near area communication of device 650 with other devices. External interface 662 may provide, for example, for wired communication in some implementations, or for wireless communication in other implementations, and multiple interfaces may also be used.

The memory 664 stores information within the computing device 650. The memory 664 can be implemented as one or more of a computer-readable medium or media, a volatile memory unit or units, or a non-volatile memory unit or units. Expansion memory 674 may also be provided and connected to device 650 through expansion interface 672, which may include, for example, a SIMM (Single In Line Memory Module) card interface. Such expansion memory 674 may provide extra storage space for device 650, or may also store applications or other information for device 650. Specifically, expansion memory 674 may include instructions to carry out or supplement the processes described above, and may include secure information also. Thus, for example, expansion memory 674 may be provide as a security module for device 650, and may be programmed with instructions that permit secure use of device 650. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 664, expansion memory 674, memory on processor 652, or a propagated signal that may be received, for example, over transceiver 668 or external interface 662.

Device 650 may communicate wirelessly through communication interface 666, which may include digital signal processing circuitry where necessary. Communication interface 666 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 668. In addition, short-range communication may occur, such as using a Bluetooth, WiFi, or other such transceiver (not shown). In addition, GPS (Global Positioning System) receiver module 670 may provide additional navigation- and location-related wireless data to device 650, which may be used as appropriate by applications running on device 650.

Device 650 may also communicate audibly using audio codec 660, which may receive spoken information from a user and convert it to usable digital information. Audio codec 660 may likewise generate audible sound for a user, such as through a speaker, e.g., in a handset of device 650. Such sound may include sound from voice telephone calls, may include recorded sound (e.g., voice messages, music files, and so forth) and may also include sound generated by applications operating on device 650.

The computing device 650 may be implemented in a number of different forms, as shown in the figure. For example, it may be implemented as a cellular telephone 680. It may also be implemented as part of a smartphone 682, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” includes any computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the processes and techniques described herein. For example, report generator 320 may be further configured to calculate derivative information of the statistical information described herein.

In another example, the techniques described herein may be used to determine an effectiveness of a GUI on a marketing campaign. For example, using the techniques described herein, a marketer could measure an incremental rate of conversions based on a number and/or type of GUIs that are displayed to a test group and to a control group.

Additionally, using the techniques described herein, a marketer could determine an effectiveness of a physical coupon that is delivered to various users. For example, one type of physical coupon could be test coupons that are delivered to a test group. Another type of physical coupons could be control coupons that are delivered to a control group. The coupons, both the control and test coupons, may include a bar code that a vendor may scan at a point of purchase. Based on an identifier associated with the bar code, the system described herein determines whether the conversion (e.g., the purchase) is attributable to the control coupon or to the test coupon. Using the techniques described herein, the system measures an incremental conversion rate that is attributable to the test coupons.

Using the techniques described herein, the system may also calculate a website's probability of generating the biggest “lift” or incremental conversion rate. That is, using the techniques described herein, the system determines the websites that generated the most conversions from the placement of an advertising campaign, for example, advertising campaign 110. For example, the system calculates an incremental conversion rate per website that displayed advertising campaign 110.

In another example, the system calculates an impact of lift (e.g., incremental conversion rate) using surveys. In this example, an advertiser shows an advertisement to a consumer and, while the advertisement is shown, a survey is also displayed. The consumer is provided with the option of filling out the survey. Based on the survey results, the system uses the techniques described herein to measure an impact of the advertisement on the consumer. For example, the system could present the consumer with the survey after the consumer has viewed the advertisement twice and then again after the consumer has viewed the advertisement five times. Based on the survey results, the system measures an incremental impact of displaying the advertisement to the consumer twice vs. displaying the advertisement to the consumer five times.

In another example, a confidence interval may be used in calculating any of the measurements described herein. For example, the system may calculate an incremental conversion rate of 3%. However, the confidence interval surrounding the conversion rate may be +/−0.1%. Naturally, the more data the system collects the more narrow the confidence interval becomes. Conversely, the more narrowly data is sliced in generating statistics, such as incremental conversion rate vs. incremental rate per a web site, the larger the confidence interval becomes. In an example, the system performs a computation to determine the size of the control group. The size of the control group should be large enough to permit statistical significance with high probability but small enough to reduce the cost of the control group's advertisements (or pointers).

In yet another example, using the techniques described herein, the system generates a control group of 5000 users and a test group of 50,000 users. In this example, 100,000 “impressions” are displayed to the control group and 1,000,000 impressions are displayed to the test group. Generally, an impression includes a display of an advertisement, including a campaign advertisement and/or a control advertisement.

In this example, 200 conversions are attributable to the control group and 5000 conversions are attributable to the test group. Accordingly, the conversion rate for the control group is 0.2% (e.g., 200/100,000)+confidence interval, if the system uses a confidence interval.

Additionally, in this example, 5000 conversions are attributable to the campaign advertisement. Accordingly, the conversion rate for the test group is 5%+confidence interval, if the system uses a confidence interval.

In this example, the control group has not been exposed to the campaign advertisement. Because the campaign advertisement presumably encourages conversions, the control group's conversion rate of 0.2% reflects the inherent, uninfluenced conversion rate. However, the test group has been exposed to the campaign advertisement. Accordingly, the conversion rate of the test group is the sum of the uninfluenced conversion rate plus the incremental (e.g., influenced) conversion rate. The incremental conversion rate of 0.3% (+a confidence interval, as applicable) may be calculated by subtracting the uninfluenced conversion rate of 0.2% from the conversion rate of the test group (e.g., 5%-2%).

In another example, the system described here supports multiple test groups with one control group. Having multiple test groups permits running multiple experiments with the same control group. Each identifier is included in exactly one group. In this example, the control group should be large enough compared with the number of users in the smallest test group to permit statistic significance of the resulting statistics.

In yet another example, advertisements can be tagged. For example, an advertisement may be served, but it is only sometimes displayed. In this example, the system described does not tag advertisements. Rather, the system categorizes advertisements into test and control groups, as described above. Additionally, the system records which advertisements are displayed. Because the system is able to use the conversion map to determine which advertisements and/or conversions are related to the test group and to the control group, advertisements do not need to be tagged to determine whether an advertisement was served to a user in the control group or to a user in the test group.

In still another example, an experiment may be run for a long period of time (e.g., three months). During the period of time, users are kept in their assigned groups and shown pointers relevant to the user's assigned group during the experiment.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims. Although a few implementations have been described in detail above, other modifications are possible. Moreover, other mechanisms for editing voice may be used. In addition, the logic flows depicted in the figures do not require the particular order shown, or sequential order, to achieve desirable results. Other steps may be provided, or steps may be eliminated, from the described flows, and other components may be added to, or removed from, the described systems. Accordingly, other embodiments not specifically described herein are also within the scope of the following claims.

1.-20. (canceled)

21. A method for determining incremental conversions attributable to an advertisement, the method comprising:
serving to a computing device, using one or more processing devices, an advertisement that is either a campaign advertisement or a control advertisement, the advertisement comprising a first tag transmitting a first message when executed by the computing device, the first message including an identifier associated with the computing device and information identifying whether the campaign advertisement or the control advertisement was served to the computing device;
receiving the first message from the computing device;
retrieving, using one or more processing devices, a conversion map from a data repository, wherein the conversion map associates identifiers of computing devices to a control group or a test group, wherein the conversion map associates the identifier of the computing device with the test group or the control group based on the information identifying whether the campaign advertisement or the control advertisement was served to the computing device;
providing, using one or more processing devices, a second tag for a conversion web page, the second tag transmitting a second message when executed by the computing device, the second message including the identifier associated with the computing device;
receiving the second message from the computing device, the second message indicative of a conversion;
determining, using one or more processing devices, that the conversion is attributable to the campaign advertisement in response to determining, based on the conversion map, that the identifier of the second message is associated with the test group;
determining, using one or more processing devices, that the conversion is a naturally occurring conversion in response to determining, based on the conversion map, that the identifier of the second message is associated with the control group;
modifying, using one or more processing devices, attribution information in one or more data repositories based, at least in part, on whether the conversion indicated by the second message is attributable to the campaign advertisement or is a naturally occurring conversion and filtering the attribution information by determining whether a time since when the identifier was created is less than a predefined amount; and
determining, using one or more processing devices, a number of incremental conversions based, at least in part, on the attribution information.

22. The method of claim 21, wherein the determination of the number of incremental conversions comprises:
determining, using one or more processing devices, a number of served campaign advertisements, a number of served control advertisements, a number of conversions associated with the test group based on the attribution information, and a number of conversions associated with the control group based on the attribution information;
determining, using one or more processing devices, a first conversion rate based on the number of served control advertisements and the number of conversions associated with the control group;
determining, using one or more processing devices, a second conversion rate based on the number of served test advertisements and the number of conversions associated with the test group;
determining, using one or more processing devices, an incremental conversion rate based, at least in part, on the first conversion rate and the second conversion rate; and
determining, using one or more processing devices, the number of incremental conversions based, at least in part, on the incremental conversion rate.

23. The method of claim 21 further comprising:
receiving, at one or more processing devices, information specifying a plurality of websites from an advertiser; and
associating, using one or more processing devices, a first set of one or more websites of the plurality of websites with the test group and a second set of one or more websites of the plurality of websites with the control group.

24. The method of claim 23, wherein the served advertisement with the included first tag is the campaign advertisement if the served advertisement is served for a website of the first set of one or more websites, wherein the served advertisement with the included first tag is the control advertisement if the served advertisement is served for a website of the second set of one or more websites.

25. The method of claim 23 further comprising:
modifying, using one or more processing devices, the conversion map based, at least in part, on the association of the first set of one or more websites with the test group and the association of the second set of one or more websites with the control group.

26. The method of claim 25, wherein the second message further includes information associated with the conversion web page and wherein the determination if the conversion indicated by the second message is associated with the test group or the control group is further based on the association of the first set of one or more websites with the test group and the association of the second set of one or more websites with the control group of the conversion map.

27. The method of claim 21 further comprising:
determining, using one or more processing devices, a frequency of exposure based, at least in part, on linear regression of a number of times the computing device is exposed to the advertisement and the attribution information.

28. The method of claim 21, wherein the second message further includes information associated with whether the advertisement was clicked on, the method further comprising:
determining, using one or more processing devices, a number of incremental click-through conversions based, at least in part, on the attribution information.

29. The method of claim 28 further comprising:
determining, using one or more processing devices, a number of incremental view-through conversions based, at least in part, on the attribution information.

30. The method of claim 29 further comprising:
generating, using one or more processing devices, a report including information indicative of the number of incremental conversions, the number of incremental click-through conversions, and the number of incremental view-through conversions.

31. A system comprising:
a processing module; and
a storage device storing instructions that, when executed by the processing module, cause the processing module to perform operations comprising:
receiving a set of identifiers, each identifier associated with a computing device;
generating a first group of identifiers using the received set of identifiers, the first group of identifiers corresponding to a test group;
generating a second group of identifiers using the received set of identifiers, the second group of identifiers corresponding to a control group;
generating a conversion map based on the first group of identifiers and the second group of identifiers;
generating a tag to be included with a conversion web page, the tag outputting a message when the conversion web page is accessed by a computing device, the message including an identifier associated with the accessing computing device;
serving a first advertisement to computing devices of the first group of identifiers and a second advertisement to computing devices of the second group of identifiers;
receiving a plurality of messages from computing devices, each message of the plurality of messages indicative of a conversion;
determining if each conversion indicated by each message of the plurality of messages is associated with the test group or the control group based on the conversion map;
generating attribution information for each conversion based, at least in part, on the determination of if the each conversion indicated by each message of the plurality of messages is associated with the test group or the control group; and
determining a number of incremental conversions based, at least in part, on the attribution information.

32. The system of claim 31, wherein the conversion map includes first information of a first conversion web page associated with the first advertisement and second information of a second conversion web page associated with the second advertisement.

33. The system of claim 31, wherein the message further includes information associated with whether the first advertisement was clicked on, wherein the storage device storing instructions that, when executed by the processing module, cause the processing module to perform operations further comprising:
determining a number of incremental click-through conversions based, at least in part, on the attribution information.

34. The system of claim 33, wherein the storage device storing instructions that, when executed by the processing module, cause the processing module to perform operations further comprising:
determining a number of incremental view-through conversions based, at least in part, on the attribution information.

35. The system of claim 34, wherein the storage device storing instructions that, when executed by the processing module, cause the processing module to perform operations further comprising:
generating a report including information indicative of the number of incremental conversions, the number of incremental click-through conversions, and the number of incremental view-through conversions.

36. The system of claim 31, wherein the storage device storing instructions that, when executed by the processing module, cause the processing module to perform operations further comprising:
determining a frequency of exposure based, at least in part, on linear regression of a number of times each computing device associated with the first group of identifiers is exposed to the first advertisement and the attribution information.

37. A method for determining incremental conversions attributable to an advertisement, the method comprising:
receiving, at one or more processing devices, information specifying a plurality of websites from an advertiser;
associating, using one or more processing devices, a first set of one or more websites of the plurality of websites with a test group and a second set of one or more websites of the plurality of websites with a control group;
serving to a plurality of computing devices, using one or more processing devices, a plurality of campaign advertisements including a first tag with the first set of one or more websites associated with the test group, the first tag transmitting a first message when executed by a computing device, the first message including an identifier associated with the computing device;
serving to a plurality of computing devices, using one or more processing devices, a plurality of control advertisements including the first tag with the second set of one or more websites associated with the control group, wherein the first message includes information identifying whether a campaign advertisement of the plurality of campaign advertisements or a control advertisement of the plurality of control advertisements was served to each of the plurality of computing devices;
receiving, at one or more processing devices, a plurality of first messages;
generating, using one or more processing devices, a conversion map based on the received plurality of first messages, wherein the conversion map associates identifiers of the plurality of computing devices to the control group or the test group based on the information identifying whether the campaign advertisement or the control advertisement were served to each of the plurality of computing devices;
providing, using one or more processing devices, a second tag for a conversion web page, the second tag transmitting a second message when executed by a computing device, the second message including the identifier associated with the computing device;
receiving, at one or more processing devices, a plurality of second messages, each second message of the plurality of second messages indicative of a conversion;
determining, using one or more processing devices, whether each conversion indicated by each second message of the plurality of second messages is attributable to the plurality of campaign advertisements by determining, based on the conversion map, whether the identifier of each second messages is associated with the test group;
determining, using one or more processing devices, whether each conversion indicated by each second message of the plurality of second messages is a naturally occurring conversion by determining, based on the conversion map, whether the identifier of each second message is associated with the control group;
generating, using one or more processing devices, attribution information for each conversion based, at least in part, on whether each conversion is attributable to the plurality of campaign advertisements or is a naturally occurring conversion and filtering the attribution information by determining whether a time since when the identifiers were created is less than a predefined amount; and
determining, using one or more processing devices, a number of incremental conversions based, at least in part, on the attribution information.

38. The method of claim 37, wherein the determination of the number of incremental conversions comprises:
determining, using one or more processing devices, a number of served campaign advertisements, a number of served control advertisements, a number of conversions associated with the test group based on the attribution information, and a number of conversions associated with the control group based on the attribution information;
determining, using one or more processing devices, a first conversion rate based on the number of served control advertisements and the number of conversions associated with the control group;
determining, using one or more processing devices, a second conversion rate based on the number of served test advertisements and the number of conversions associated with the test group;
determining, using one or more processing devices, an incremental conversion rate based, at least in part, on the first conversion rate and the second conversion rate; and
determining, using one or more processing devices, the number of incremental conversions based, at least in part, on the incremental conversion rate.

39. The method of claim 37, wherein a second message of the plurality of second messages further includes information associated with whether one campaign advertisement of the plurality of served campaign advertisements was clicked on, the method further comprising:
determining, using one or more processing devices, a number of incremental click-through conversions based, at least in part, on the attribution information; and
determining, using one or more processing devices, a number of incremental view-through conversions based, at least in part, on the attribution information.

40. The method of claim 39 further comprising:
generating, using one or more processing devices, a report including information indicative of the number of incremental conversions, the number of incremental click-through conversions, and the number of incremental view-through conversions.
